(19) United States
(12) Patent Application Publication
(10) Pub. No.: US 2017/0011374 A1
(43) Pub. Date: Jan. 12, 2017

(54) POINT OF SALE KIOSK FOR DISPENSING POKER-STYLE CHIPS AND TICKETS OF VARIOUS DENOMINATIONS AND DESIGNATIONS AND METHOD THEREOF

(71) Applicant: Shaun McDivitt, Las Vegas, NV (US)

(72) Inventor: Shaun McDivitt, Las Vegas, NV (US)

(73) Assignee: Entertainment Financial Solutions, LLC, Las Vegas, NV (US)

(21) Appl. No.: 14/793,710

(22) Filed: Jul. 7, 2015

(51) Int. Cl. G06Q 20/18; G06K 7/08; G06Q 20/40

(52) U.S. Cl. CPC G06Q 20/18; G06Q 20/40145; G06Q 20/409; G06K 7/087

(57) ABSTRACT

A poker-style nylon chip dispensing kiosk including a touch screen display, key pad input module, credit card scanner, bill validator, chip dispensing mechanism and chip vault for holding chips, a dispensing assembly for dispensing selected numbers of chips and security and input systems to allow an end user to access the kiosk and have the kiosk dispense selected numbers of chips. The kiosk is interactive with the owners accounting system so as to report the dispensing of chips.

### CROSS-REFERENCE TO RELATED APPLICATIONS

Ser. No. 14/62,022,160

### FEDERALLY SPONSORED RESEARCH

None

### SEQUENCE LISTING

None

### TECHNICAL FIELD OF INVENTION (FOI)

The present invention is generally directed to the field of cash, voucher, and casino chip or poker-style nylon, clay, ceramic, metal or plastic chip management and in particular to a device and process whereby poker-style nylon chips can be stored and easily accessed by an operator or user to provide a supply of poker-style nylon chips to gaming stations or other type of receiver within a select area of an given establishment. The invention contemplates a kiosk for dispensing cash, voucher, and poker-style nylon chips from a secure vault upon receipt of proper authorization, or proper point of sale transaction and an accounting system to track distributions and receipts of the selected output.

The present invention is generally directed to the field of cash, voucher, and casino chip or poker-style nylon, clay, ceramic, metal or plastic chip management and in particular to a device and process whereby poker-style nylon chips can be stored and easily accessed by an operator or user to provide a supply of poker-style nylon chips to gaming stations or other type of receiver within a select area of an given establishment. The invention contemplates a kiosk for dispensing cash, voucher, and poker-style nylon chips from a secure vault upon receipt of proper authorization, or proper point of sale transaction and an accounting system to track distributions and receipts of the selected output.

### BACKGROUND

The present invention relates to cash, voucher, and poker-style nylon, clay, ceramic, metal or plastic chips dispensing machines that can be customized for a specific establishment as a voucher or payment for services therein. Examples of various embodiments include, but are not limited to, large gaming casinos, restaurants, bars and taverns, gentleman's clubs, massage salons, arcades, amusement or theme parks, and many other unspecified uses.

For example, modern large casinos have evolved to incorporate hundreds or thousands of slot machines or other types of coin or ticket operated gaming machines. However, gaming tables where players can play blackjack, poker games, roulette or craps remain as a mainstay of the casino design. Generally, the slot machines are placed around one or more gaming table pit areas. A single pit area may include card tables such as blackjack or poker tables, roulette tables and crap tables. The pit areas are generally positioned in a central portion of an open area within the casino. Each pit area is provided the poker-style nylon chips from an accounting cage and a back room area, which is discreetly and securely located away from the center of activity within a casino. In order to open a gaming table, it is necessary for the casino to arrange to have casino chips delivered from a caged vault area across the casino floor to the gaming table located in a particular pit area or grouping of gaming tables. Restocking of a gaming table during the course of play may be necessary if a patron has several wins and additional chips are necessary. Restocking a gaming table during the course of a play can be distracting to the players and cause the casinos to lose revenue if a successful player must wait for additional casino chips to be delivered to the gaming table. Additionally, in modern casinos there is no option or available device for a general casino patron to purchase chips from an automated kiosk without casino personnel intervention at the gaming tables or casino cage.

Previous devices are deficient from the point of view of a patron or consumer with a desire to purchase poker-style nylon chips for use as currency for games or for vouchers for various services at a given establishment. Further, the current devices require a combination of mechanics to determine certain money, coupons, or other voucher amount that are deposited in the kiosk to determine the appropriate action depending on whether the required amount is deposited. The present invention is based off of a credit card point of sale methodology that will transact and authorize any given and appropriate transaction for the given establishment and dispense the appropriate poker-style nylon chip, voucher, or credit for the given amount or desired service.

Some examples of the variety of machines which dispense stamps, tickets, coupons, money orders, bank transactions or the like can be summarized in the following. One type of machine, shown in U.S. Pat. No. 5,039,848, dispenses coupons in exchange for money. A display area indicates the different coupons available as well as the specific amount of money required to obtain each particular coupon. Money is inserted into the machine via a coin slot. Control circuitry determines which coupon has been selected, the amount of money required to purchase this coupon, and if the correct amount of money has been inserted into the coin slot. The control circuitry then causes the coupon dispenser to dispense the requested coupon. This prior art is a good example of an electronic kiosk that dispense a voucher, but this machine does not consider the voucher to be a poker-style nylon chip with various allocations of services or amounts on the chip.

Other machines dispense other types of products. For instance, U.S. Pat. No. 5,021,967 is a money order dispensing machine. This machine is meant to be operated by a system operator, not a customer, and therefore does not require the capability to receive money. The machine prints money orders on a dot matrix printer after receiving the necessary data inputs from the operator. Clearly, this machine is an outdated form of kiosk and once again does not consider the poker-style nylon chip model or point of sale methodology to the end user as the current embodiments do for our present invention.

Such previous devices are deficient from the point of view of a consumer with a desire for a point of sale transaction with cash or credit card, since the previous devices require the input of an exact coin value. Further, the device requires a mechanism for determining if the required amount has been deposited and for taking an appropriate action depending on whether the required amount is deposited. Additionally, there is also different variety of machines that have been patented which sort coins. One such machine, shown in U.S. Pat. No. 4,995,848 uses two methods to sort coins, both methods based on the diameter of the coins. In this machine the coins are loaded into a hopper. A rotating wheel feeds the coins individually onto an inclined ramp. The coins roll down the ramp with their rear surfaces resting against a support surface. Specific denominations are selected when they fall through slots of varying size located in the support surface. Specific denominations are also selected using peeler knives which are arranged at different distances from the ramp surface. These knives topple the coins from the ramp into bins. Using both techniques allows a short ramp to be employed. Another type of machine shown in U.S. Pat. No. 4,059,122 counts the number of coins according to denomination after sorting the coins. These machines are similar in the fact that they are kiosks with an end user in mind but fall short of providing poker-style nylon chip dispensing capabilities and end user point of sale integration.

Furthermore, a number of counting and sorting devices are deficient for certain other reasons. Many devices, while having some form of waste control device, have been unsuccessful in completely controlling waste which may be mixed in with coins. As a result, many previous devices are only suitable for operation by an experienced or skilled operator and are not suitable for use by the general public who may be less careful about including foreign or waste material among coins. In particular, many previous devices were designed to admit coins into the counting device at such a rate that it was not possible for each coin to be individually exposed to the waste control device, i.e., such that some coins may block others from the waste control system.

Some counting/sorting devices have had complicated or ineffective control of the flow of coins so that it was difficult, or expensive to prevent unacceptably high surges of coin flow from jamming or otherwise overwhelming the sorting/counting mechanism. Some devices were designed to permit only a slow entry of coins into the counting/sorting mechanism but, in some cases, this was done at the expense of the ability to accommodate a high volume of coins and/or has resulted in unacceptably slow operation.

Additionally, when considering a poker-style nylon chip kiosk in a modern casino operations it would be beneficial to have the ability to restock a gaming table with casino chips from a position located proximate to the pit area. However, since the casino chips can be utilized as money within the casino, and have values from one dollar to several thousand dollars, accounting for the casino chips and security of the casino chips within the accounting system is mandatory.

Accordingly, it would be advantageous to provide a machine that is designed as a customer facing end user kiosk which does not require intervention of an employee to process a cash or credit card transaction, with all the proper security and authorization, and deliver directly to the patron or user a poker-style nylon chip with a specific denomination for monetary use or a specific service within the given establishment and redemption of the same. It would be further advantageous to provide a device which provides for effective and efficient poker-style nylon chip management such that the device can be used by the ordinary consumer without resulting in jamming or damage of the machine. It would also be advantageous to provide for a device which accommodates a high volume or flow of poker-style nylon chips without permitting surges of chip flow which can interfere with the counting/sorting and point of sale management systems, without overly but sufficient electronic integration of machinery and, preferably, taking advantage of a gravity mechanism of the nylon style chips.

As such, the present invention considers the kiosk and coin dispensing machines of the past but provides new and interesting uses for multiple industries that would like to integrate a voucher in the form of a poker-style nylon chip or for industries that currently use said chips as an integral part of their business model. No other machine provides for dispensing cash, vouchers, and poker-style nylon chip from a kiosk as the result of a point of sale transaction for currency or service.

### SUMMARY

The present invention is directed to a cash, voucher, and nylon chip dispensing kiosk including a vault for holding the poker-style nylon, clay, ceramic, metal or plastic chips, a dispensing assembly for dispensing selected numbers of poker-style chips and security and input systems to allow a user or patron to access the kiosk and have the kiosk dispense selected numbers of poker-style nylon chips directly to the user, a point of sale system that will process a cash or credit card transaction which may be processed through a remote application on a mobile device interfacing with the kiosk with all the appropriate security and authorization for the use of obtain the poker-style nylon chips from the kiosk. The kiosk is interactive with the establishment's accounting system so as to report the dispensing of poker-style nylon chips or receipt of chips. Security features built into the kiosk as well as into the establishments monitor the dispensing of the poker-style nylon chips and delivery of the chips to the appropriate user or patron. Such features may include tracking the radio frequency identification (RFID), unique ultraviolet marking, or bar code affixed to the chip identifying the denomination and/or specific inventory number of the chip. By the present invention, the kiosk can be stocked with a substantial number of poker-style nylon chips as necessary to provide the various stations or tables within the establishment's business model with sufficient chips to satisfy the anticipated requirements of a shift or daily operation, and thereby enabling the end user control of how many chips are purchased and in circulation for the various services or monetary transactions on the floor—i.e. betting on casino tables.

The user interface is comprised of visual and auditory instructions guiding the transaction with the kiosk. The visual display screen will provide a graphical user interface in conjunction with a number key pad with braille. The auditory instructions will be provided out of speakers incorporated to the kiosk or through a universal headphone jack. The headphones enable effective communication auditory instructions for the hearing impaired or in environments where ambient noise may drown out or confuse the customer. For example, the kiosk will instruct the customer to press a particular key to dispense cash or a different key to credit the customer's account.

A present and primary embodiment envisions usage in a gentleman's club for point of sale applications of various denominations and services offered within the club. This embodiment may have chip designations for private dances, tipping of staff, club paraphernalia and souvenirs, food, and all other various goods and services within the club. The kiosk and application will eliminate the need for cash or isolated credit card purchases during the stay at the club. This embodiment will simplify the user experience and allow for easier transactions via the use of specific designated chips. Additionally, this embodiment may be placed in remote areas designed to attract potential customers. For example, a kiosk placed at the airport may provide a terminal to purchase drink tokens or vouchers with a complimentary token for transportation and entry to the gentleman's club.

In some embodiments, the point of sale kiosk will interface to a database account providing rewards for preferred customers, which may include customer data such as a customer balance and a customer identification key or account number. The amount debited or credited to the kiosk may be assessed against a customer's existing account.

In some embodiments, the point of sale kiosk a secured network such as a wireless local area network (WLAN) will provide internet connectivity. The customer will be allowed to access banking or other payment websites such as PayPal to withdraw, deposit, or exchange currency for a chip of equivalent value, credit toward the customer's account, voucher, or other dispensable output provided by the kiosk.

In some embodiments, the kiosk will provide charging services for electronic devices such as mobile phones, tablet personal computers, or the like.

According to some other embodiments, the kiosk chip dispenser machine comprises custom poker-style nylon chips for gaming and casino establishments that can be used in traditional methods by casino management and administrators for the distribution of casino specific chips. Additionally, the device may incorporate an input bar code reader to accept ticket in ticket out (TITO) printouts to credit payouts of other TITO systems, most commonly TITO slot machines, for chips, currency, redeemable vouchers for services or the like, or credit toward the respective gaming account of the user. Further, the kiosk may include an output for the TITO system, enabling the printing of vouchers including a bar code representing differing values or vouchers for various goods or services as required by the establishment.

According to some other embodiments, the kiosk will incorporate biometric identification to access the customer's account. The required biometric sensor will be placed on the kiosk. A central network system retaining the biometric data interfaces with the kiosk. When the appropriate biometric data, such as a fingerprint, is entered into the biometric sensor, the kiosk will grant access to the customer's account, permitting full use of the services associated with the account.

According to additional embodiments, the kiosk machine comprises custom poker-style nylon chips for services performed at a given establishment such as a massage parlor, salon, amusement park or theme based service. The poker-style nylon chip kiosk would process a point of sale transaction for a given cost of service and dispense a unique nylon chip as a voucher for said service to eliminate the employee from handling any money or credit card information of the user.

Optionally, the kiosk can also provide secure storage for various point of sale transaction documents that may be required to maintain compliance with existing or future regulations for tracking poker-style nylon chip removal and deposit events at the kiosk. Such documents can provide not only an accounting trail for the movement of all chips in and out of the chip kiosk, but also their movement from and to the various gaming tables or services and or players in the venue. These event transaction documents can be in the preferred form of machine printable and readable tickets or cards or as a backup in the form of hand written forms that are issued by the respective personnel and inserted into the kiosk for secure storage until they can be transported along with the other contents of the kiosk vault to a secured location or accounting room for verification and tabulation.

Another anticipated option to the kiosk discloser herein is a monitoring service notifying the central distribution system when the amount of output falls below a minimum threshold. This notification would alert the servicer of the kiosk to transport additional materials to the kiosk to ensure continued full functionality. For example, should the kiosk dispense poker-style nylon chips that depletes its stock below ten percent of its maximum capacity, the servicing agent can be dispatched to manually refill the kiosk.

Another anticipated option to the poker-style nylon chip kiosk system disclosed herein, are various forms of secure electrical or wireless signals that can be used for requesting, approving, and/or confirming such chip transfers between the chip kiosk, the establishment providing the kiosk service and the end user. These event signals can easily be encrypted by various means known in the art and can originate either from proprietary codes keyed into keypads at the kiosk, employee workstation, and/or gaming tables by employee personnel or through secure transmissions from wireless portable personal data devices issued to authorized personnel. These signals are then easily monitored and tracked by one or more of the processors linked to the kiosk system components. Security of such event signals can be insured through any number of means known to those skilled in the art including but not limited to encryption, personal access codes, biometric scanning devices, proprietary communication protocols, unique RFID tags, and/or personal unique integrated circuit chip cards.

This summary is not intended to identify key features or essential features of the claimed subject matter, nor is it intended to be used as an aid in determining the scope of the claimed subject matter. Additional features and advantages of exemplary implementations of the present disclosure will be set forth below, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF DRAWINGS

An embodiment of the present invention will hereinafter be described in conjunction with the appended drawings, provided to illustrate and not to limit the invention, in which:

FIG. 1: is a perspective view of the poker-style nylon chip kiosk with the LCD display, input pad, credit card scanner, without the chip vault and computer control unit exposed.

FIG. 2: is a front and rear a perspective view of the poker-style nylon chip kiosk with the LCD display, input pad, credit card scanner, without the chip vault and computer control unit exposed.

FIG. 3: is a front schematic view of the poker-style nylon chip kiosk with the service door fully opened displaying the innards of the kiosk.

FIG. 4: is a front schematic view of the poker-style nylon chip kiosk with the service door opened and the innards of the kiosk partially displayed.

FIG. 5: is a front schematic view of the poker-style nylon chip kiosk with the service door closed.

FIG. 6: is a front perspective view of an alternative aesthetic design of the poker-style nylon chip kiosk.

FIG. 7: is a screen shot process and methodology or walk-through for a user to obtain certain poker-style nylon chips as consideration for a debit or credit card transaction. Screen capture 001: is a screen capture of a welcome screen displayed on the screen of the kiosk. Screen capture 002: is a screen capture of a purchase screen displayed on the screen of the kiosk. Screen capture 003: is a screen capture of a purchase confirmation screen displayed on the screen of the kiosk. Screen capture 004: is a screen capture of a payment selection screen displayed on the screen of the kiosk. Screen capture 005: is a screen capture of a payment instruction screen displayed on the screen of the kiosk. Screen capture 006: is a screen capture of a payment authorization screen for a debit card displayed on the screen of the kiosk. Screen capture 007: is a screen capture of a payment authorization screen for a credit card displayed on the screen of the kiosk. Screen capture 008: is a screen capture of a terms of use screen for a debit card displayed on the screen of the kiosk. Screen capture 009: is a screen capture of a payment confirmation screen on the screen of the kiosk. Screen capture 010: is a screen capture of a cancellation screen displayed on the screen of the kiosk. Screen capture 011: is a screen capture of an error screen displayed on the screen of the kiosk.

### DETAILED DESCRIPTION OF DRAWINGS

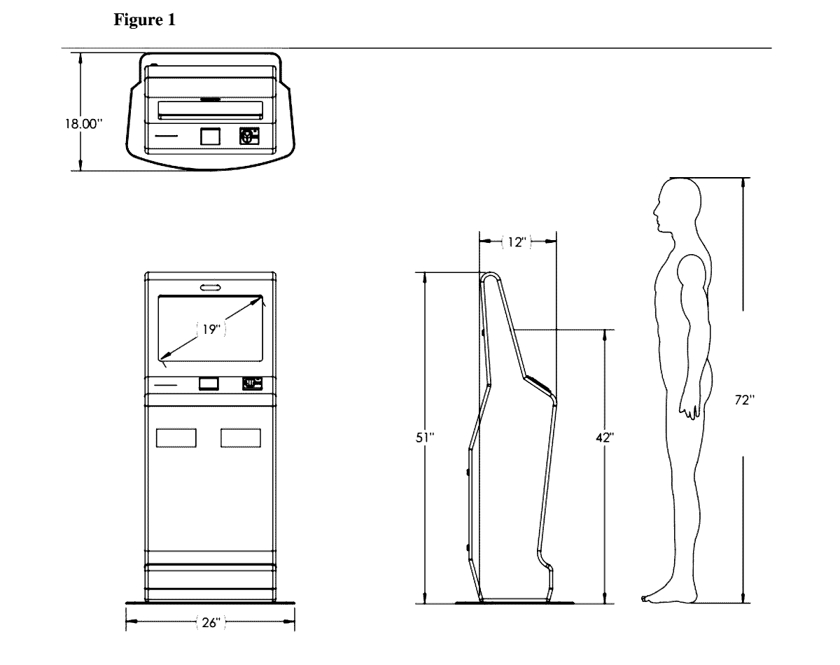

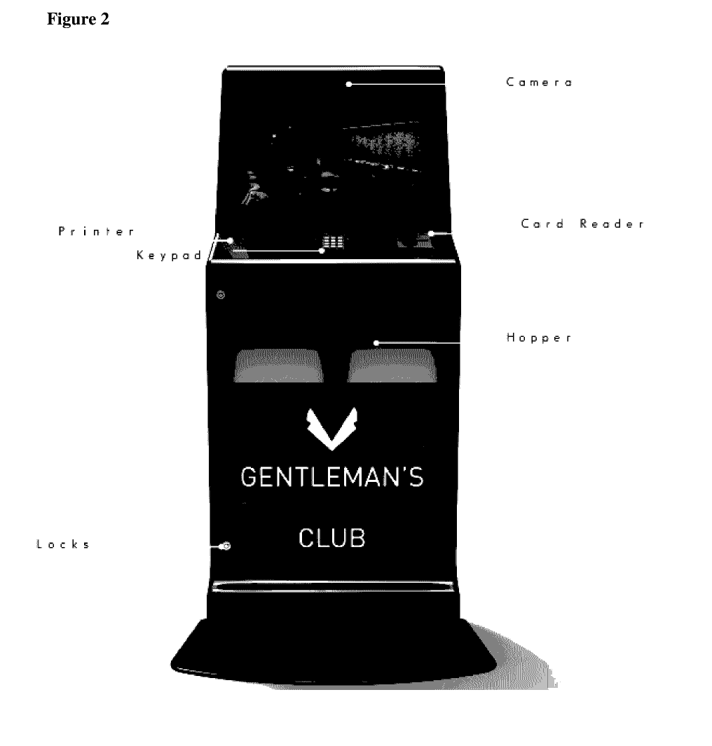

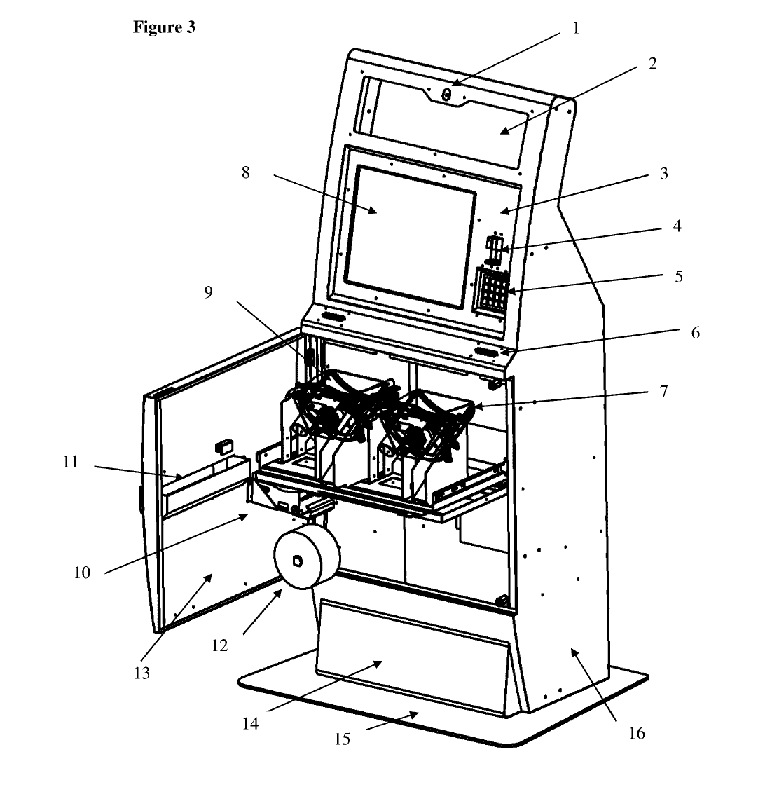

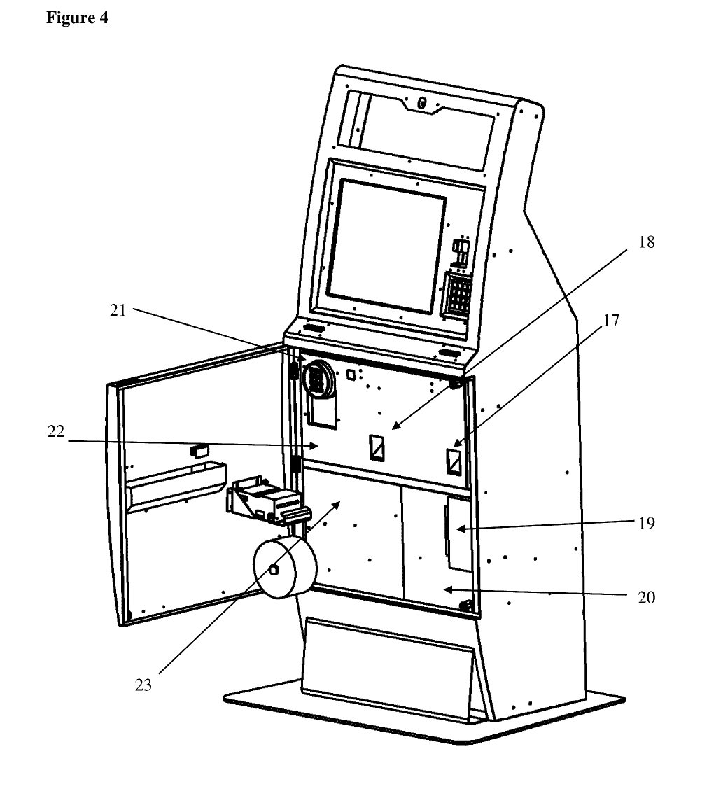

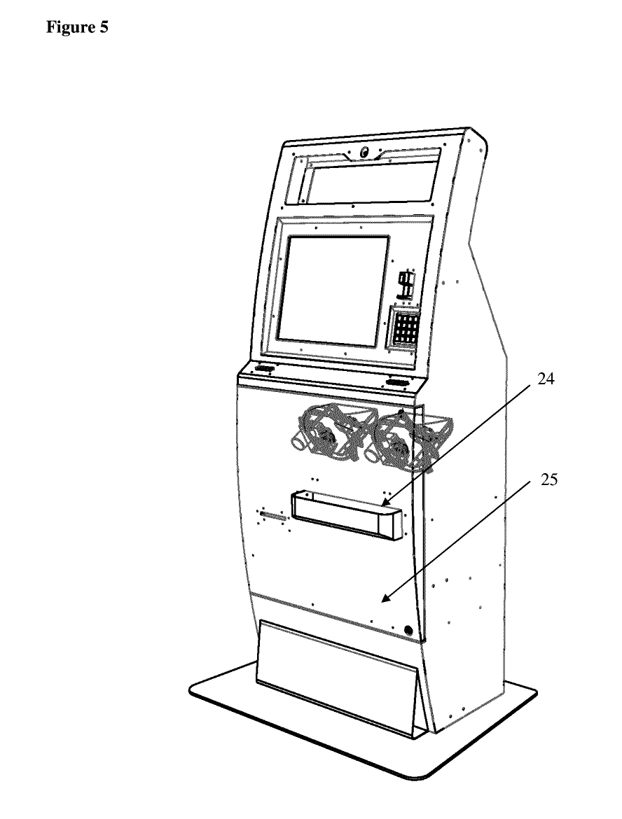

FIG. 1 and FIG. 2 depict front perspective views of the poker-style nylon chip kiosk with the LCD display 8, input pad 5, credit card scanner 4, without the chip vault and computer control unit exposed. A certain embodiment of a kiosk includes a standing floor chassis with a common LED display 8 capable of touchscreen interaction, an Intel i3 NUC kit with an industry standard dual chip set for the computer control system 19, a magnetic stripe reader 4, two custom WH3 Asahi Seiko chip hopper 7 with LED lights to illuminate chip distribution, industry standard cooling fans, common Logitech camera 1, EMV compliant modular keypad with multiple input readers 5, a Lemur-K industry standard printer 10. An EMV compliant modular keypad 5 can be configured to enable EMV chip, PIN, and magnetic stripe transactions, as well as contactless electronic payment via common e-wallet transmission vectors combined. A Lemur-K industry standard printer 10 enables direct thermal printing for receipts, vouchers, or other tangible printouts for use in conjunction with poker-style nylon chip kiosk. All elements listed in a certain embodiment are modular and not specific to all embodiments of the present invention.

A current embodiment includes an industry standard camera 1 that enables a portrait picture or isolated video of the end user interaction and authorization of the kiosk transaction. The computer control system 19 and software will provide a face screen scan, which provides verified usage data for the user or credit card agency that requires proof of usage and fraud prevention. This option and functionality will allow the establishment owner to retain patron/user facial profile when the kiosk is used or engaged y use the machine. The computer control system 19 and software can identify the user and send a confirming text or email of the transaction and can also retain regular usage patterns to identify frequent users so the proprietors can obtain helpful analytics to incentivize and cater to VIP users.

A chip vault includes chip dispensing chutes 17 and 18 on the front thereof that mates with and provides chips from two custom WH3 Asahi Seiko chip hopper 7 to the external chip dispensing tray 11 and 24 of the chip dispensing kiosk. The external chip dispensing 11 and 24 tray may be lined with LED lights for added aesthetic appeal. The chip vault also includes a chip receiving drop slot, which is configured to be below the chip drop slot and chip validator on the top of the chip dispensing kiosk. The chip vault also includes either or both of an optical coupler or an electronic coupling contacts to provide information and data exchange capabilities as well as power to the chip vault from the chip dispensing kiosk. In addition, the chip vault preferably includes a bill intake slot through which cash received by the bill acceptor slot are passed for storage within the bill compartment of the chip vault.

Optionally, the chip vault also includes a document intake slot juxtaposed to the document drop slot of the chip dispensing kiosk through which documents pass to the secure document compartment. Generally, one side of the chip vault may be attached so as to allow access to the inside of the chip vault to allow for restocking of the chips contained therein in the count room. Of course the chips secured within the chip vault cannot be removed other than via dispensing from within the chip dispensing kiosk wherein each dispensing is tracked and monitored and only permitted upon proper security and authorization.

Optionally, the chip kiosk has two access doors 22 and 25 locked on the outside with industry standard locks for basic security measures. As seen in FIG. 4, certain embodiments also include an electronic interior lock mechanism 21 that requires administrator authentication for increased and redundant security precautions.

Optionally, the chip kiosk can include a tracking device to allow the establishment to physically track the location of the chip kiosk at all times even if it is moved through the location or to a secure room for accounting purposes. Such technology is commonly used today in many forms. Global positioning system (“GPS”) devices and Global System for Mobile Communications (“GSM”) devices provide the capability to show the location of the attached device relatively accurately on a real time basis. RFID tags can also be used for this purpose.

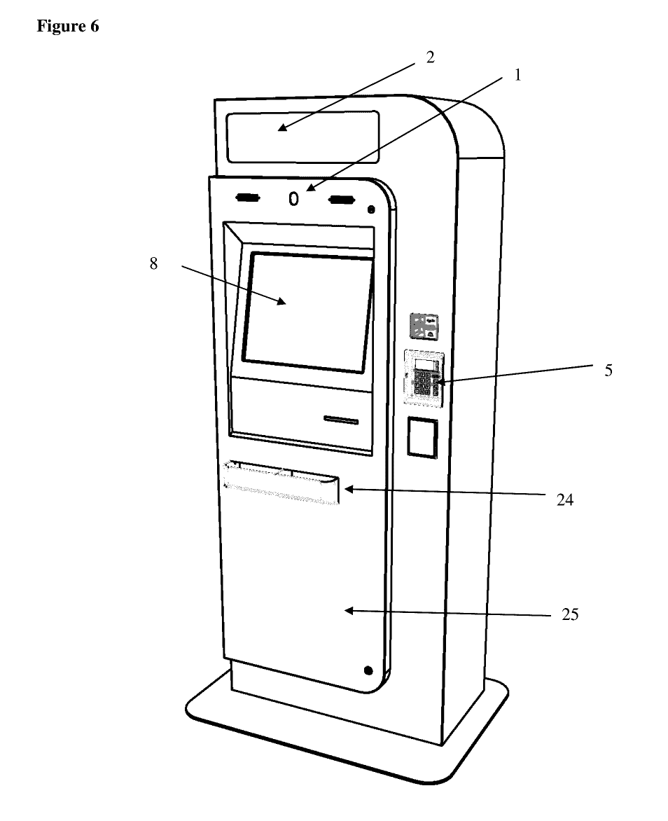

FIG. 3 depicts a diagram of the major components of the chip dispensing kiosk as well as the chip vault. A standing floor chassis with a reinforced kick plate 14, a base 15, and side panels 16 and 23 and back panel 20 forms the external body of the kiosk which houses the kiosk control assembly.

The kiosk control assembly houses a control system 19, which is the primary controller for the entire chip dispensing kiosk. The control system 19 is in operative communication with the Ethernet, as described with respect to FIG. 1, and there by with the various other computer terminals at the location or on the network. Within the chip dispensing kiosk, the control system interacts with a credit card point of sale system or bill validator, which is positioned within the system housing. The bill validator and credit card reader 4 can be a standard validator, which is available from many vendors capable of reading a credit card authorization chip or magnetic strip, as well as reading various currencies. If a standard note validator is used here the control system could obviously be programmed to dispense chips in return for cash inserted therein or the desired service of the user.

The control system 19 is a computer electrically interconnected to the screen display 8. The screen display 8 can be an LED type of display or a plasma display, which can provide or display information concerning the status of the chip dispensing kiosk, including the amount and number of poker-style nylon chips, which are stored in the chip vault at any given time, the amount of chips requested in a fill a transaction request from the end user, and the amount of chips deposited into the chip dispensing kiosk via the chip deposit bezel and chip drop slot. The screen display may also include a biometric security device such as a thumb print scanner or hand scanner that will allow added security to control access to the chips within the chip dispensing kiosk. Thus, for example, only the approved employee or owner would be able to access the chips within chip dispensing kiosk and authorize the chip dispensing kiosk to dispense chips by a thumb or a hand scan on the biometric screen on the screen display.

The computer control system 19 is also electrically interconnected to the touch pad or key pad 5 that may be on the touch screen display 8 or on a separate touch pad. The touch pad 8 or key pad 5 can be either a touch screen 8 prompt of information that can be typed into the control system or keypads such as standard numeric or alphanumeric keys, which may be used to enter data into the control system to provide specific instructions on various events that may be necessary. For example, the touchpad 8 or keypad 5 could be utilized to identify a specific employee or user who will be authorized during the course of an event to access the chip dispensing kiosk, to input specific information as to chip requests or fill events necessary for a specific table and other similar types of data inputting.

The computer control system 19 is preferably also interconnected to a chip reader to enable proper chip dispensing. The chip reader is positioned below the chip drop slot to read chips that are inserted through the chip drop slot and passed to the chip vault via drop slot on the top of the chip vault. The chip reader may be an optical reader or an RFID reader capable of reading, characterizing information on chips as they pass thru the drop slot. RFID reading devices of the type that can read RFID embedded chips are known in the art as discussed within U.S. Pat. No. 5,735,742 to Chip Track International. Alternatively, the chip reader may be an optical reader or a combination of an optical and an RFID reader. The optical reader identifies certain encoded optical information on a surface of casino chips to provide an indication of the value of each casino chip as it passes through the drop slot.

The computer control system 19 is electrically interconnected to communication devices, which could include optical devices, or electrical devices that can communicate across the space between the chip dispensing kiosk and the removable chip vault. Within the chip vault, an optical receiver and electrical contacts are configured to be oppositely disposed with respect to the electrical devises and optical devises of the communications devices of the chip dispensing kiosk when the chip vault is properly in placed within the chip dispensing kiosk. Preferably, the chip vault includes a memory and control component that is communicatively coupled to the electrical contact and optical receiver, so that information concerning the amount of chips, for example, that are stored in the chip vault may be communicated to the computer control system 19 as well as communicated to a remote location for monitoring purposes and so as to download information as to either the number of chips remaining or are stored within the chip vault.

Preferably the chip dispensing kiosk is powered by a standard 2-wire power cord egressing from the rear of the kiosk. Some embodiments would also include an uninterruptible power source (UPS) which provides protection from power spikes as well as providing battery backup in case of power failures. This will not only ensure preservation of data but also allow sufficient time to complete any data or chip processing that may be happening at the time of an eventual power outage.

The chip vault may also include a bill stacker, which, if necessary, includes electrical power coupling to allow a power drive motor to drive belts to store tickets received by the bill validator of the chip dispensing kiosk within the chip vault, so that when the chip vault is taken from the chip dispensing kiosk to the count room, the tickets identifying each dispensing of poker-style nylon chips can be compared with the information in the memory and computer control component, concerning chips, which were deposited via the drop slot, and the amount of chips remaining in the chip vault, to properly account for the intake and dispensing of each chip to and from the chip vault.

In operation, the chip vault is loaded with a certain number of chips, once the chips are loaded, the chip vault is secured in a locked and closed position. The number of chips and each denomination of each chip is reported via the optical coupling to the memory control component of the chip vault. The chip vault is secured in place and the door is locked. Once the door is locked, the locking of the door is reported to the control system of the chip dispensing kiosk. The computer control system then communicates through the communication devices with the chip vault to download the information from the memory as to the stocking of chips within the chip vault. The control system then communicates the identification of the particular chip in the vault as well as the amount of chips within the chip vault to the remote monitoring server or workstation. The computer control system reports to the chip vault that the identification of the chip vault has been validated and then the chip vault will be unlocked to allow dispensing of chips from the chip dispensing kiosk and specifically the chip vault therein.

FIG. 4 depicts a supplemental diagram of an embodiment of the chip kiosk with the chip vault secured via an electronic interior lock mechanism 21 that requires administrator authentication for increased and redundant security precautions. An electronic interior lock mechanism may interface with the computer control system 19 to log access. The internal chip vault housing 22 with electronic locking mechanism opens downward permitting access to the chip vault. The housing contains two apertures 17 and 18 permitting transfer from two custom WH3 Asahi Seiko chip hopper 7 to the external chip dispensing tray 11 and 24.

FIG. 5 depicts a supplemental diagram of an embodiment of the chip kiosk showing the location of the external chip dispensing tray 11 and 24 with an external swinging door 25 securing access to the chip vault and computer control unit 19.

FIG. 6 depicts an alternative design of a plurality of designs incorporating features of a kiosk including the same functionality as the chip kiosk depicted in FIG. 1 through FIG. 5.

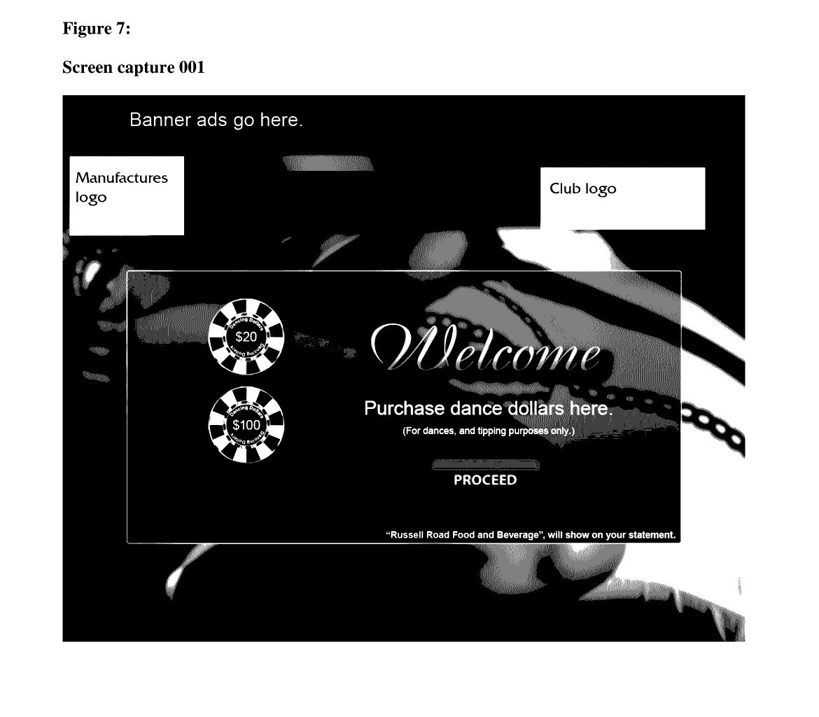

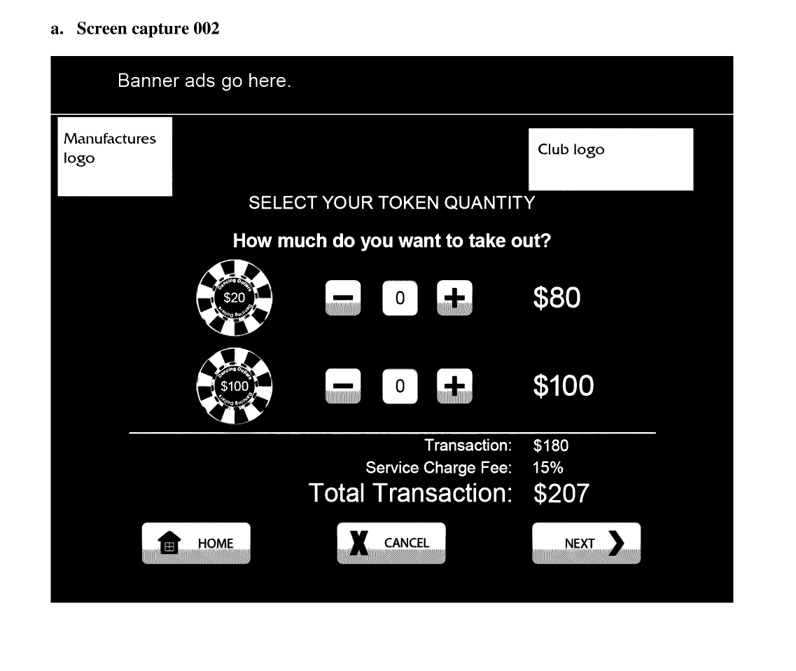

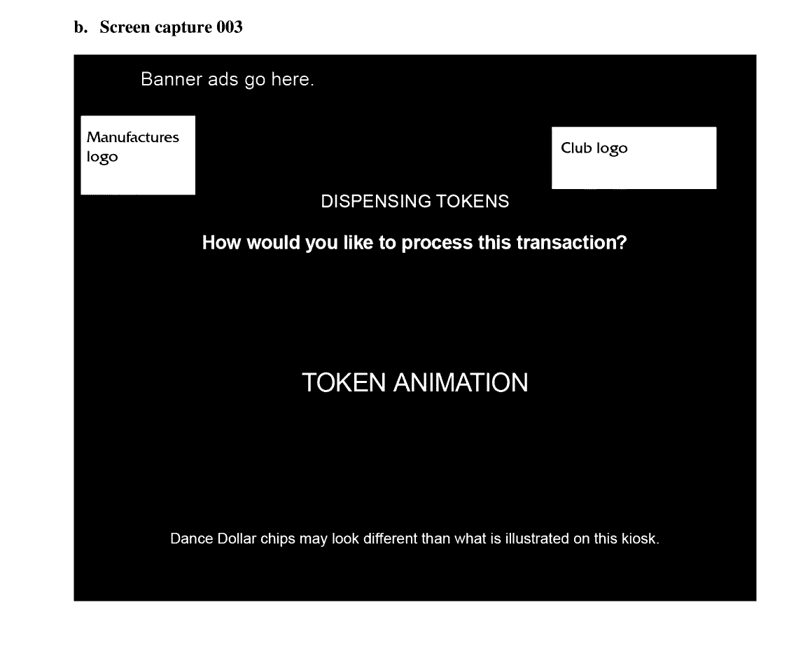

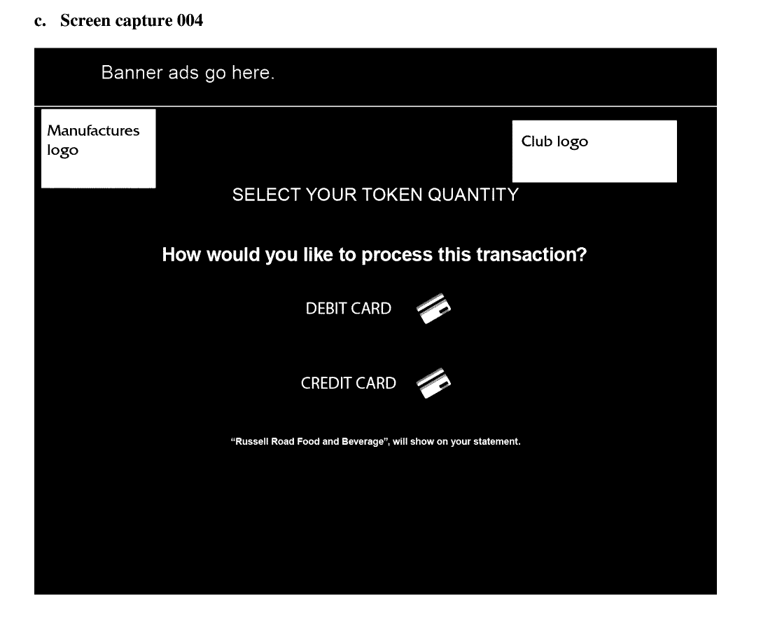

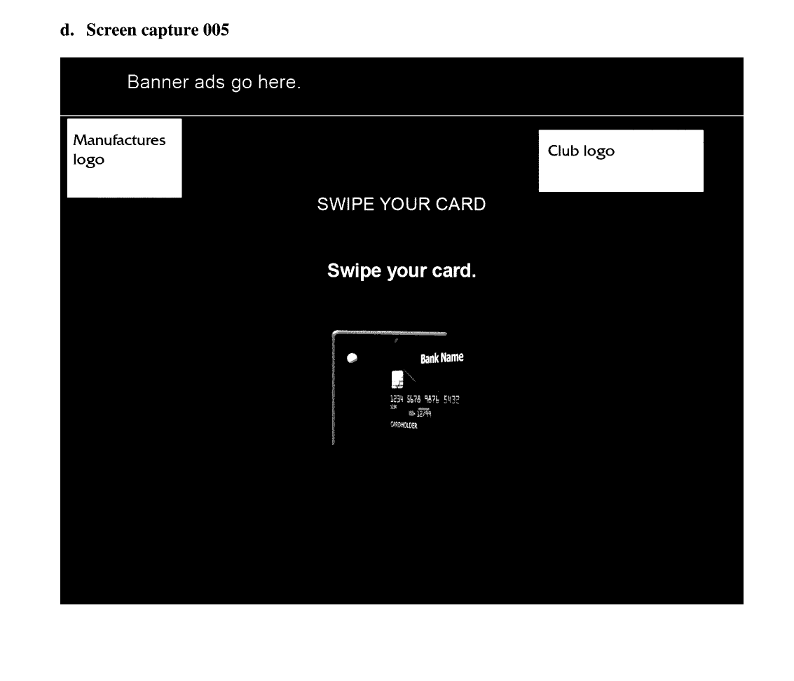

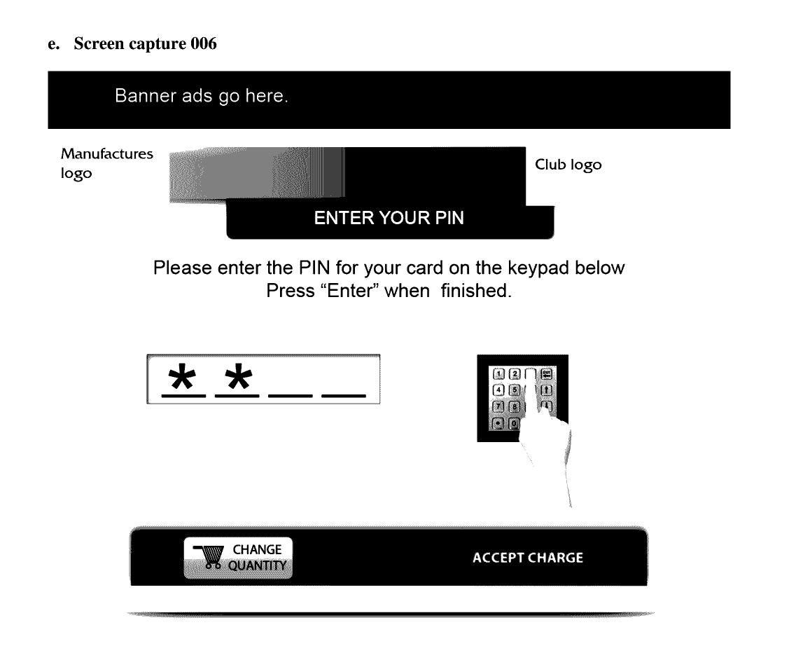

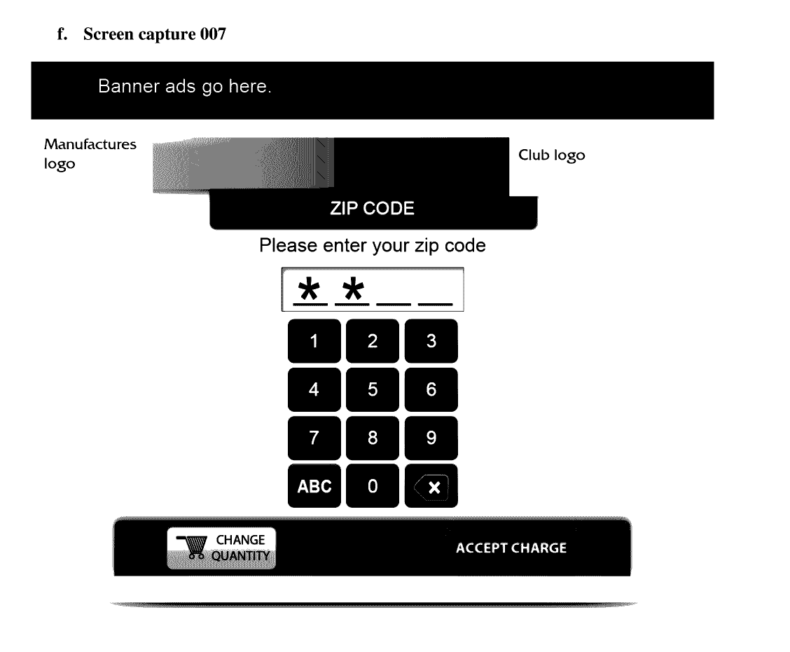

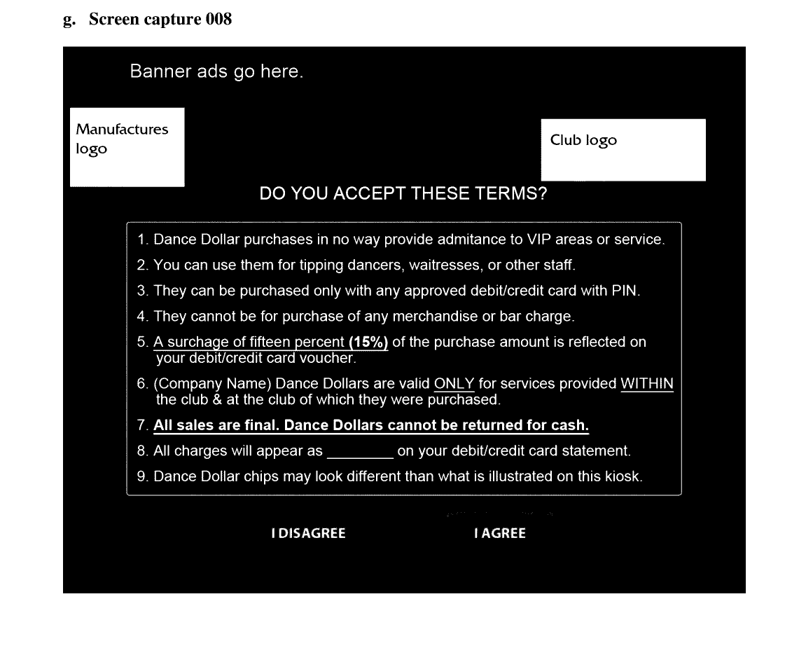

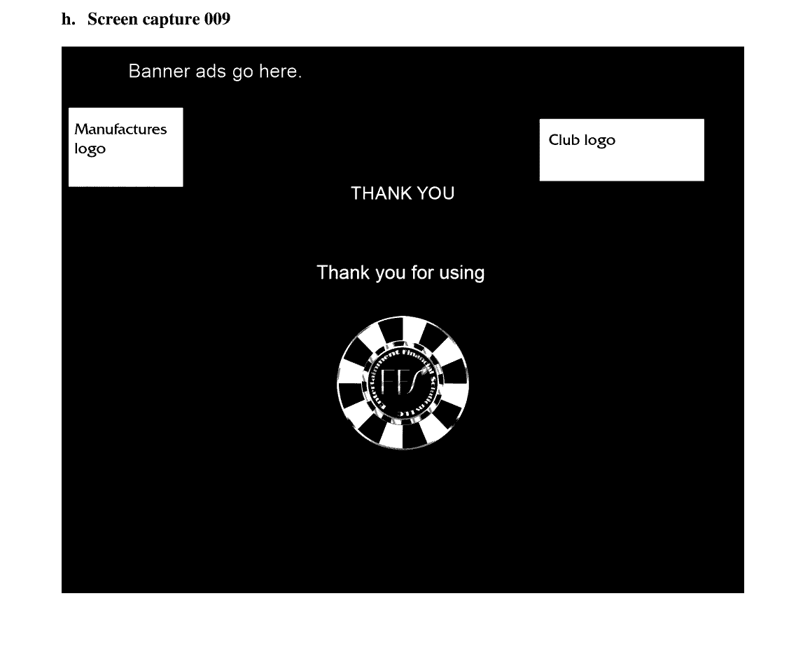

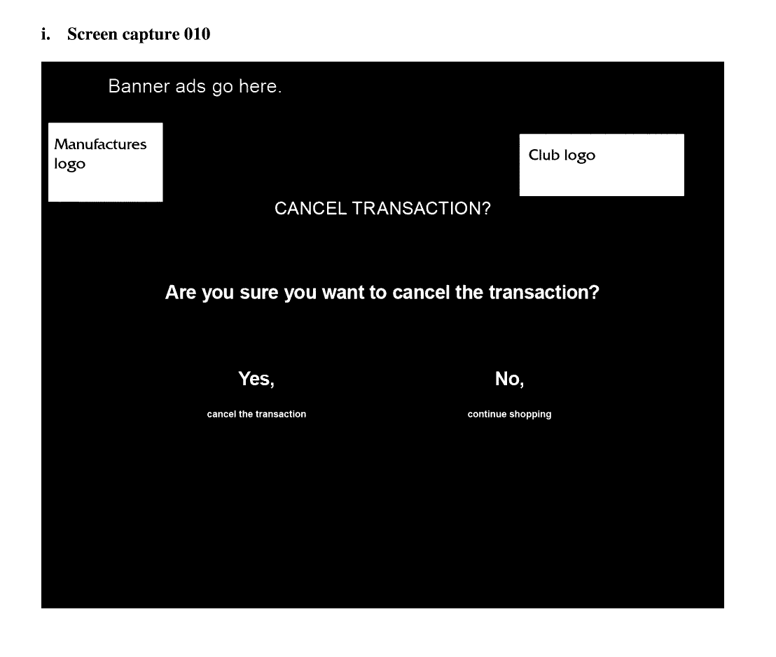

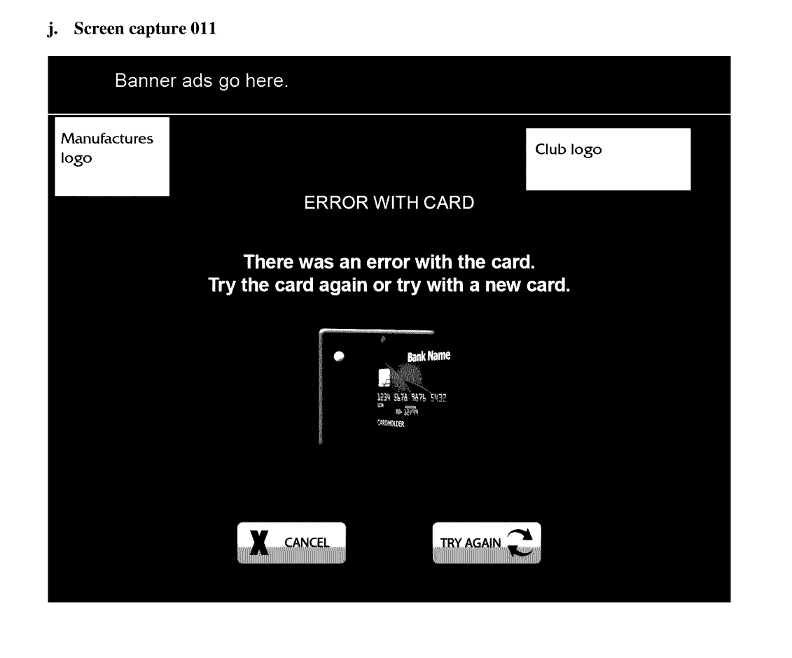

FIG. 7 depicts a series of screen captures from the computer control system 19 and the point of sale mechanics in a certain embodiment specific to a gentleman's club specializing in exotic dancing. The interface of the point of sale would be displayed on the terminal or interactive display within the kiosk housing. The captures demonstrate the usage of a patron to obtain certain poker-style nylon chips for a specified monetary amount without the need to interact with any employee of the establishment. Said poker-style nylon chips can then be redeemed within the establishment for the services indicated on the chips. This embodiment does not consider any biometric or other form of authentication as in other embodiments but serves as a description of a point of sale transaction with the automated chip dispensing kiosk.

a. Screen 001 is a welcome screen with an introduction to the service and the kiosk. It would provide certain marketing and advertisement options for the owner or advertise, but more specifically this screen shot is the entry point for the transaction. Legal disclaimers and the terms of use may also be mentioned on this screen as well as the services provided within the establishment.

b. Screen 002 is a quantity and quality determination by the user. Various chips are offered for varies amounts with a sub-total and tax levy as described. This embodiment may also provide chips as vouchers for fully legal services provided by the establishment, such as private dances, cocktails, food menu items, etc. The amount of chips and nature of the chips are tabulated by the computer control system and the display notifies the user of the total costs of the transaction. Additional legal disclaimers and advertising material may appear as directed by the owner and operator of the kiosk.

c. Screen 003 is a confirmation of the users desire to proceed with the desired chip dispensing and the total cost of the transaction. In this embodiment, there may be additional animation to appeal to the users and engage or entice the user to complete the transaction. Additional legal disclaimers and advertising material may appear as directed by the owner and operator of the kiosk.

d. Screen 004 is the determinate of payment of the user. In this specific embodiment only a debit or credit card would be available, but in various other embodiments' cash and voucher tickets may also be a viable means of purchase for the poker-style nylon chips. Additional legal disclaimers and advertising material may appear as directed by the owner and operator of the kiosk.

e. Screen 005 depicts the direction for the user to properly swipe his credit card in the reader. The computer control system captures the magnetic data from the card and utilizes well established authentication protocols from the credit card industry to properly identify and authenticate the user. Client server model of authentication is used in the embodiment as depicted in the next screen, Screen 006, which requires the user to enter the primary PIN number for a debit card and Screen 007 requires the user to enter proper zip code billing address for the chosen card. The computer control system negotiations as the point of sale terminal with the credit card server to authenticate the user. The system also allows the user a final “accept charge” verification to insure that the transaction is valid and authorized. In some embodiments, as small portrait camera may also be installed in the chassis of the kiosk to capture an authentication picture of the user confirming the transaction. If there was an electronic error or authentication error the computer control system will produce Screen 011 to require the user to re-swipe the desired card and start. the transaction anew.

f. Screen 008 depicts the terms of use for the dispensing kiosk and the financial transaction to take place via the kiosk. This screenshot and element of the process may be inserted into the flow at the appropriate place depending on the legal jurisdiction of the kiosk and the requirements of the specific industry utilizing the kiosk. Additional legal disclaimers and advertising material may appear as directed by the owner and operator of the kiosk.

g. Screen 009 depicts the confirmation of the transaction wherein the kiosk processed the debit or credit card authorization and dispensed the proper chip denominations or services. The screen also expresses the gratitude of the establishment and owner. Additional legal disclaimers and advertising material may appear as directed by the owner and operator of the kiosk.

h. Screen 010 depicts a cancellation screen that can be inserted in the process at any time depending the status of the kiosk, the willingness of the user to proceed, or some other variable that does not allow a proper transaction to occur. Additional legal disclaimers and advertising material may appear as directed by the owner and operator of the kiosk.

In view of the foregoing discussion, it may be readily understood that alternative embodiments are contemplated. Having thus described different embodiments of the invention, other variations and embodiments that do not depart from the spirit of the invention will become readily apparent to those skilled in the art. The scope of the present invention is thus not limited to any one particular embodiment, but is instead set forth in the appended claims and the legal equivalents thereof.

We claim:

1. A poker-style nylon chip dispensing kiosk to provide chips for a plurality of chip gaming stations or other services within a business or establishment comprising:
A housing;
A chip vault configured to be secured within said housing;
A plurality of poker-style nylon chip stacker assemblies within said chip vault to bank chips;
A bill validator configured to identify characteristics of bills;
A credit or debit card scanner and reader;
A keypad or other data entry module; and
A computer control system coupled to said card scanner and bill validator and said chip vault to control the dispensing of chips from said chip vault.

2. The kiosk of claim 1, further comprising a communication link to communicate with an administration computer configured to monitor transactions from the kiosk over a network.

3. The kiosk of claim 1, further comprising a data input device for allowing an operator to provide instructions to said control system of said kiosk.

4. The kiosk of claim 1, further comprising a data input device commonly the LCD touchscreen display or keypad entry module for allowing an end user to provide instructions to said control system of said kiosk.

5. The kiosk of claim 1, further comprising a biometric security device interconnected to said computer control system for accepting biometric information to authorize transactions performed by said casino chip dispensing kiosk.

6. The kiosk of claim 1, further comprising a biometric recognition device interconnected to said computer control system for accepting biometric information to collect user data by said casino chip dispensing kiosk.

7. The kiosk of claim 1, wherein said housing and said chip vault are located in various locations within various business, including but not limited to, large gaming casinos, restaurants, bars and taverns, gentleman's clubs, massage salons, arcades, amusement or theme parks, and many other unspecified uses.

8. The kiosk of claim 1, wherein said chip vault further comprises an electronic tracking device.

9. The kiosk of claim 1, wherein said chip vault further comprises a chip reader for automatically sensing chip denominations and various services specific to the industry of usage.

10. A method of poker-style nylon chip transaction management for the automation and validation of fill event transactions for end users from one or more chip dispensing kiosks positioned within a specific business, the steps comprised of:
Providing at least one kiosk processor within the specified location,
Initiating a fill event request by an end user at said kiosk,
Communicating said request from said kiosk to authorization authority for debit and credit card transaction,
Receiving the requested quantity of poker-style nylon chips at the at least one dispensing kiosk.

11. A container or chip vault configured to occupy a holding position and a dumping position, the container being configured to hold a load when in the holding position, the container having a center of gravity, a frame configured to support the container, the frame having a forward portion and a rearward portion, a locking mechanism configured to releasable secure the container in the holding position;
Wherein the container is secured to the frame at a pivot point, the pivot point being located forward of the center of gravity of the container, and
Wherein the containers operation dispenses the appropriate poker-style nylon chips for the desired transaction.
